(19) United States
(12) Patent Application Publication
(10) Pub. No.: US 2024/0049200 A1
(43) Pub. Date: Feb. 8, 2024

(54) SUB-BAND INDICATION FOR SUB-BAND FULL DUPLEX (SBFD) WIRELESS COMMUNICATION

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Abdelrahman Mohamed Ahmed Mohamed IBRAHIM, San Diego, CA (US); Tao LUO, San Diego, CA (US)

(21) Appl. No.: 17/881,481

(22) Filed: Aug. 4, 2022

(51) Int. Cl. H04W 72/04; H04L 5/16

(52) U.S. Cl. CPC H04W 72/0453; H04L 5/16

(57) ABSTRACT

Aspects of the disclosure provide techniques for wireless communication using sub-band full duplex (SBFD). A network entity can inform a user equipment (UE) on the allocation of communication resources for SBFD operations using sub-bands. The network entity can indicate sub-band allocation in symbols/slots configured for SBFD operations using various techniques. A UE can receive a SBFD configuration of one or more time slots, each time slot including a plurality of symbols. The SBFD configuration indicates that one or more of the plurality of symbols are capable of an SBFD operation using a first sub-band for downlink (DL) communication and a second sub-band for uplink (UL) communication. The UE can communicate with the network entity in the one or more symbols configured for the SBFD operation using at least one of the first sub-band for DL communication or the second sub-band for UL communication.

### TECHNICAL FIELD

The technology discussed below relates generally to wireless communication systems, and more particularly, to sub-band full duplex (SBFD) wireless communication and sub-band configuration indication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

To reduce uplink latency and increase the coverage of the uplink transmissions, sub-band full duplex (SBFD) communication may be used in which an SBFD time slot can support frequency duplexing for simultaneous uplink and downlink transmissions. The bandwidth of the SBFD slot can be divided into multiple sub-bands, for example, one uplink sub-band and two downlink sub-bands.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of the disclosure provide techniques for wireless communication using sub-band full duplex (SBFD) communication. A network entity can inform a user equipment on the allocation of communication resources for SBFD operations using different sub-bands for uplink and downlink communications. The network entity can indicate sub-band allocation in symbols/slots configured for SBFD operations using various techniques.

One aspect of the disclosure provides a method of wireless communication at a user equipment (UE). The UE receives, from a network entity, a sub-band full duplex (SBFD) configuration of one or more time slots, each time slot comprising a plurality of symbols. The SBFD configuration indicates one or more of the plurality of symbols being capable of an SBFD operation using a first sub-band for downlink (DL) communication and a second sub-band for uplink (UL) communication. The UE communicates with the network entity in the one or more symbols configured for the SBFD operation using at least one of the first sub-band for DL communication or the second sub-band for UL communication.

One aspect of the disclosure provides a user equipment (UE) that includes a memory stored with executable code, and a processor coupled to the memory and configured by the executable code. The processor is configured to receive, from a network entity, a sub-band full duplex (SBFD) configuration of one or more time slots, each time slot including a plurality of symbols. The SBFD configuration indicates one or more of the plurality of symbols being capable of an SBFD operation using a first sub-band for downlink (DL) communication and a second sub-band for uplink (UL) communication. The processor is further configured to communicate with the network entity in the one or more symbols configured for the SBFD operation using at least one of the first sub-band for DL communication or the second sub-band for UL communication.

One aspect of the disclosure provides a method of wireless communication at a network entity. The network entity provides a sub-band full duplex (SBFD) configuration of one or more time slots, each time slot comprising a plurality of symbols. The SBFD configuration indicates one or more of the plurality of symbols being capable of an SBFD operation using a first sub-band for downlink (DL) communication and a second sub-band for uplink (UL) communication. The network entity communicates with a user equipment (UE) in the one or more symbols configured for the SBFD operation using at least one of the first sub-band for DL communication or the second sub-band for UL communication.

One aspect of the disclosure provides a network entity including a memory stored with executable code, and a processor coupled to the memory and configured by the executable code. The processor is configured to provide a sub-band full duplex (SBFD) configuration of one or more time slots, each time slot including a plurality of symbols. The SBFD configuration indicates one or more of the plurality of symbols being capable of an SBFD operation using a first sub-band for downlink (DL) communication and a second sub-band for uplink (UL) communication. The processor is further configured to communicate with a user equipment (UE) in the one or more symbols configured for the SBFD operation using at least one of the first sub-band for DL communication or the second sub-band for UL communication.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is an illustration of an exemplary disaggregated base station architecture according to some aspects.

FIG. 4 is a schematic illustration of an organization of wireless resources in an air interface utilizing orthogonal frequency divisional multiplexing (OFDM) according to some aspects.

FIG. 5 is a diagram illustrating an exemplary SBFD resource configuration of communication resources according to some aspects.

FIG. 6 is a diagram illustrating an exemplary network entity equipped with multiple antenna arrays usable for SBFD communication according to some aspects.

FIG. 7 is a signaling diagram illustrating exemplary signaling for configuration SBFD communication between a network entity and a UE according to some aspects.

FIG. 8 is a diagram illustrating a scheme for indicating SBFD symbol(s) using according to some aspects.

FIG. 9 is a diagram illustrating a scheme for indicating SBFD symbol(s) using dynamic signaling according to some aspects.

FIG. 10 is a block diagram illustrating an example of a hardware implementation for a network entity according to some aspects.

FIG. 11 is a flow chart illustrating an exemplary process at a network entity for indicating an SBFD configuration in wireless communication according to some aspects.

FIG. 12 is a block diagram illustrating an example of a hardware implementation for a user equipment according to some aspects.

FIG. 13 is a flow chart illustrating an exemplary process at a user equipment for indicating SBFD configuration in wireless communication according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chips and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and UE), end-user devices, etc. of varying sizes, shapes and constitution.

Aspects of the disclosure provide techniques for wireless communication using sub-band full duplex (SBFD) communication. A network entity can inform a user equipment on the allocation of communication resources for SBFD operations using different sub-bands for uplink and downlink communications. The network entity can indicate sub-band allocation in symbols/slots configured for SBFD operations.

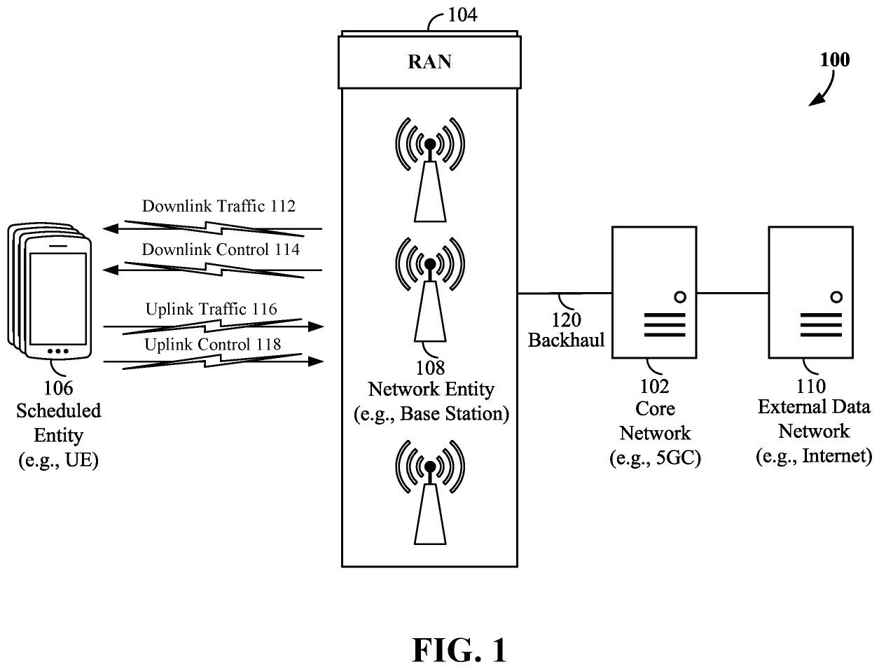

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100.

The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of network entity 108. Broadly, a network entity can be a network element in a radio access network responsible for radio transmission and reception in one or more cells to or from a UE. In different technologies, standards, or contexts, a network entity may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity 108 (e.g., base station) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network entity 108). Another way to describe this scheme may be to use the term broadcast channel multiplexing. Transmissions from a UE (e.g., UE 106) to a network entity 108 (e.g., a base station) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a network entity 108 (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Network entities 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, network entities 108 may include a backhaul interface for communication with a backhaul portion 120 of the wireless communication system. The backhaul 120 may provide a link between a network entity 108 and the core network 102. Further, in some examples, a backhaul network may provide interconnection between the respective network entities 108 (e.g., base stations). Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

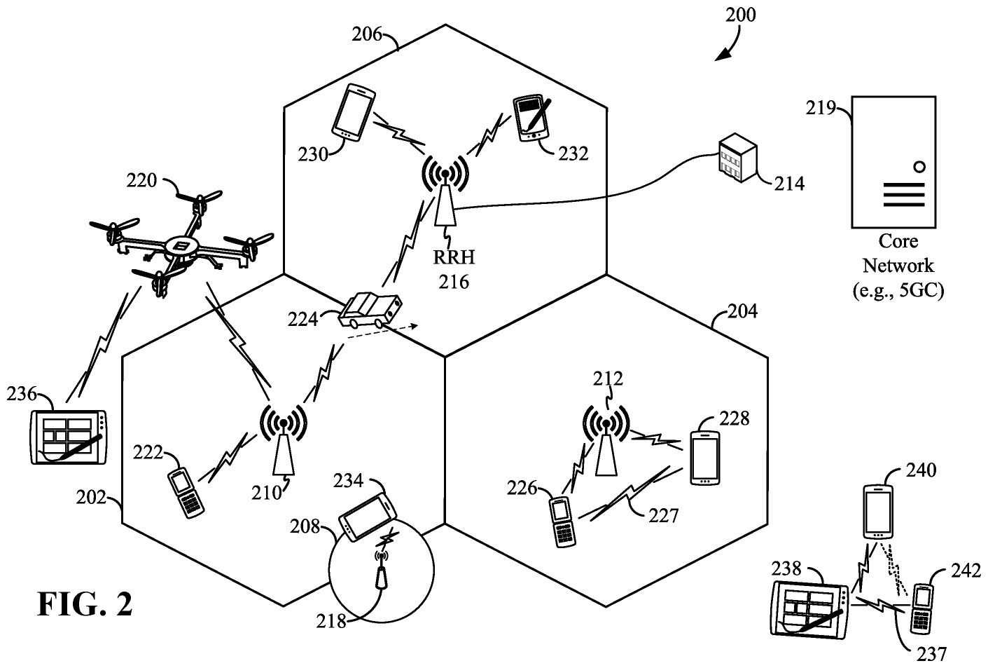

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a UE based on an identification broadcasted from a network entity (e.g., one access point or base station). FIG. 2 illustrates cells 202, 204, 206, and 208, each of which may include one or more sectors (not shown). A sector is a sub-area of a cell. All sectors within one cell are served by the same network entity (e.g., base station). A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity arrangements can be utilized. For example, in FIG. 2, two network entities (e.g., base station 210 and base station 212) are shown in cells 202 and 204. A third network entity (e.g., base station 214) is shown controlling a remote radio head (RRH) 216 in cell 206. In this example, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network 219 for any number of mobile apparatuses. The core network 219 may be independent of the radio access technology used in the RAN 200. In some examples, the core network 219 may be configured according to 5G standards (e.g., 5GC, NR). In other examples, the core network 219 may be configured according to a 4G evolved packet core (EPC), or any other suitable standard or configuration. The RAN 200 and the core network 219 can be connected via a wireless or wired connection.

FIG. 2 further includes an unmanned aerial vehicle (UAV) 220, which may be a quadcopter or drone. The UAV 220 may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to the core network 219 for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220.

In some examples, the UAV 220 (e.g., quadcopter) may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In the RAN 200, the ability for a UE to communicate while moving, independent of its location, is referred to as mobility. The various physical channels between the UE and the RAN 200 are generally set up, maintained, and released under the control of an access and mobility management function (AMF, not illustrated, part of the core network 219), which may include a security context management function (SCMF) and a security anchor function (SEAF) that perform authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if the signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals (e.g., PSS, SSS, and PBCH), derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

The air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM).

In other examples, full-duplex communication may be implemented within unpaired spectrum (e.g., within a single carrier bandwidth or multiple carriers), where transmissions in different directions (e.g., UL and DL) occur within different sub-bands of the carrier bandwidth. This type of full-duplex communication may be referred to herein as sub-band full duplex (SBFD), also known as flexible duplex.

Further, the air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

In RAN 200, wireless communication can be implemented using various frequencies. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as an NB, eNB, gNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

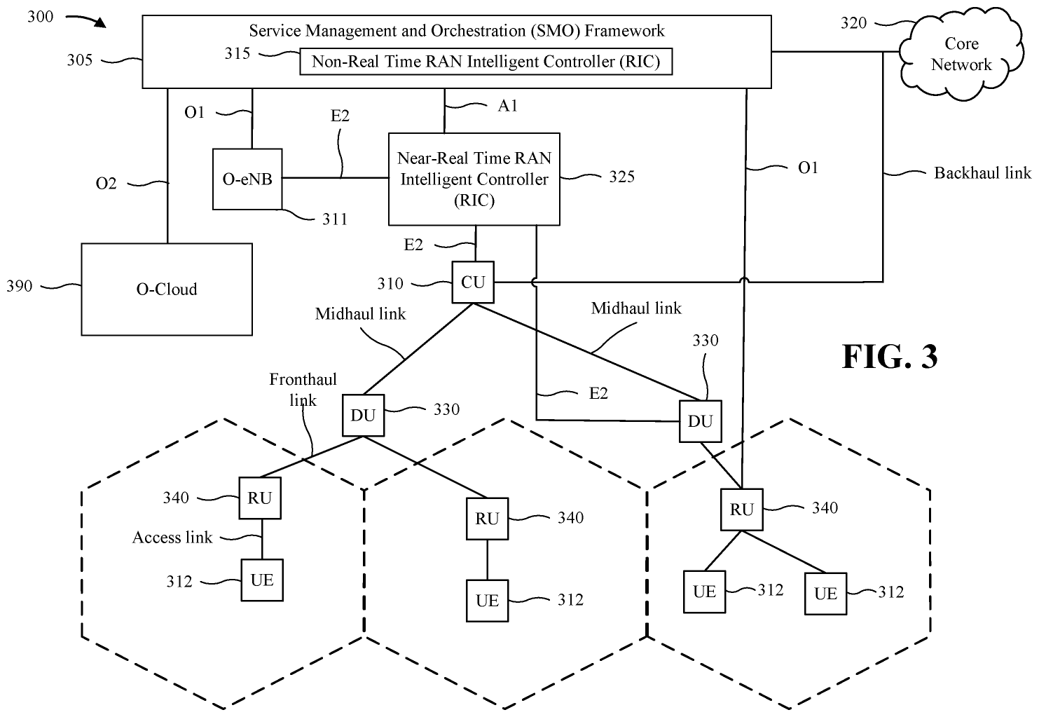

FIG. 3 shows a diagram illustrating an exemplary disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 312 via one or more radio frequency (RF) access links. In some implementations, the UE 312 may be simultaneously served by multiple RUs 340.

Each of the units, i.e., the CUs 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter, or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU X10 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low physical (PHY) layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communication with one or more UEs 312. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) X11, via an O1 interface. Additionally, in some implementations, the SMO Framework 305 can communicate directly with one or more RUs 340 via an O1 interface. The SMO Framework 305 also may include a Non-RT RIC 315 configured to support the functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC X25.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via the creation of RAN management policies (such as A1 policies).

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

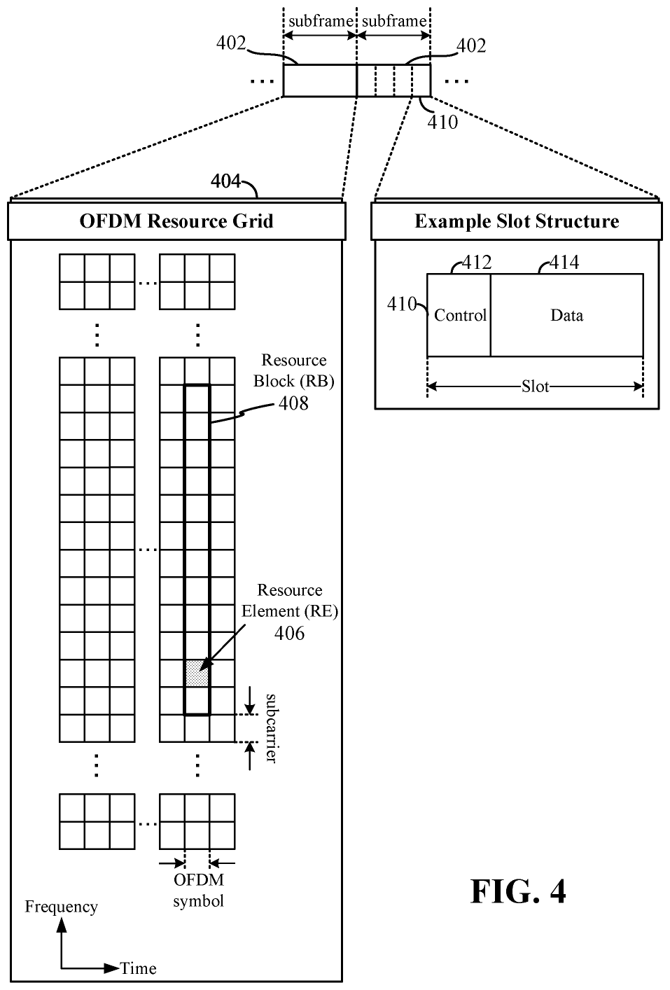

Referring now to FIG. 4, an expanded view of an exemplary subframe 402 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity or network entity, such as a base station (e.g., gNB, eNB, CU-DU, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all downlink (DL), all uplink (UL), or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, a network entity (e.g., a scheduling entity, a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and/or UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity (e.g., a base station) may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity (e.g., base station) may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

### Sub-band Full Duplex Communication

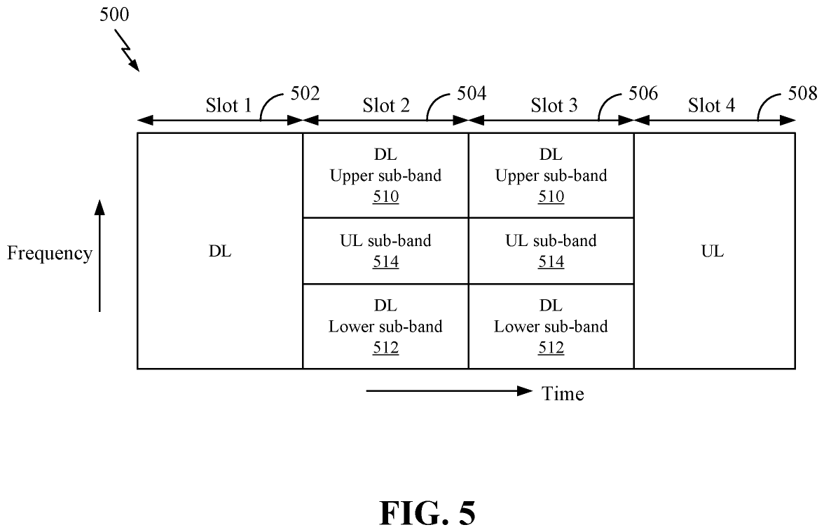

FIG. 5 is a drawing illustrating an exemplary resource configuration 500 for enabling SBFD communication according to some aspects. The SBFD resource configuration 500 includes resources (e.g., time and frequency resources) corresponding to four time slots 502, 504, 506, 508. The bandwidth of the slots can span across one or more carriers (e.g., component carriers for wireless communication). It will be appreciated that the SBFD resource configuration 500 may have other configurations with more or fewer than four slots. To reduce uplink (UL) latency and increase the UL coverage, the SBFD resource configuration 500 can provide one or more SBFD slots (e.g., slot 2 and slot 3 in FIG. 5) that can support frequency duplexing for simultaneous UL and DL transmissions using different sub-bands in the same symbol/slot. In some aspects, the first slot 502 and the fourth slot 508 may remain as half duplex time division duplex (TDD) slots. For example, the bandwidth of the first slot can be dedicated to DL communication, and the bandwidth of the fourth slot 508 can be dedicated to UL communication. In other aspects, it is contemplated that any slot may be configured to be an SBFD slot.

In some aspects, an SBFD slot (e.g., slots 504 and 506) can include one or more DL sub-bands (e.g., a DL upper sub-band 510 and a DL lower sub-band 512) and one or more UL sub-bands (e.g., an UL sub-band 514). With the SBFD slots, the network can enable flexible and dynamic UL/DL resource adaption according to UL/DL traffic in a more robust manner. For example, the network entity can change UL bandwidth and/or DL bandwidth per symbol/slot using the SBFD slots. In one example, a sub-band of an SBFD slot can span across one or more carriers. In one example, a sub-band of an SBFD slot can have a bandwidth wider or narrower than a carrier (e.g., a component carrier). The network can use SBFD slots to enhance system capacity, resource utilization, scheduling flexibility, and/or spectrum efficiency.

In an exemplary SBFD slot (e.g., slots 504 and 506 in FIG. 5), the UL portion can occupy a central sub-band in the frequency band of the SBFD slot. The DL portion can occupy a DL lower sub-band with a frequency range lower than the UL sub-band. The DL portion also can occupy a DL upper sub-band with a frequency range higher than the UL sub-band. In some aspects, the DL and UL sub-bands may be separated by a guard band. In one example, the UL sub-band may be symmetric about a center frequency for the SBFD slot. In one example, the bandwidth for the DL lower sub-band and the DL upper sub-band can be equal. However, in some aspects, the DL lower sub-band bandwidth may be different from the bandwidth of the DL upper sub-band. In some aspects, the DL upper and lower sub-bands may each have a bandwidth that may vary as 10 MHz, 20 MHz, 30 MHz, or 40 MHz depending upon the configured downlink data rate. In some aspects, the UL sub-band may not be symmetric about a center frequency for the SBFD slot.

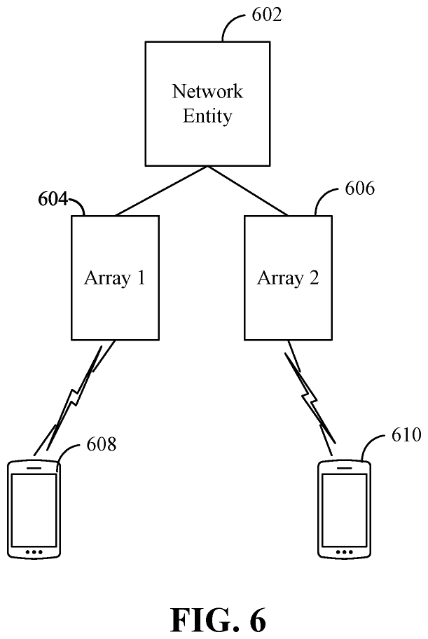

In some aspects, the frequency duplexing in the SBFD slots disclosed herein can be implemented by a network entity (e.g., a base station, gNB of FIGS. 1 and 2) and/or a UE. FIG. 6 illustrates an exemplary network entity 602 (e.g., a base station) equipped with multiple antenna arrays (e.g., a first antenna array 604 and a second antenna array 606). The antenna arrays can be separated by a physical distance to reduce potential interference (e.g., cross-link interference). During SBFD operation, one of the antenna arrays (e.g., first antenna array 604) can transmit DL communication to a first UE 608 while another antenna array (e.g., second antenna array 606) can receive an UL communication from a second UE 610. In some aspects, the UE 608/610 can use half-duplex transmission in a slot such that the UE's antenna or array is entirely dedicated to transmitting UL signals or to receiving DL signals in the respective slot(s). It will be appreciated, however, that frequency duplexing (e.g., SBFD) may also be practiced by a UE.

In some aspects, the two antenna arrays of the network entity 602 (e.g., array 604 and array 606) can both be used for DL transmission in slot 1 (see FIG. 5). Similarly, the two arrays can both be used for receiving an UL transmission in slot 4 (see FIG. 5). In both the first slot 502 and the fourth slot 508, the transmitted DL/UL signal may occupy the entire (or a portion of) bandwidth of the slot. In the SBFD slots (e.g., second and third slots 504 and 506), the network entity 602 can use the first antenna array 604 for DL communication, and the second antenna array 606 for UL communication.

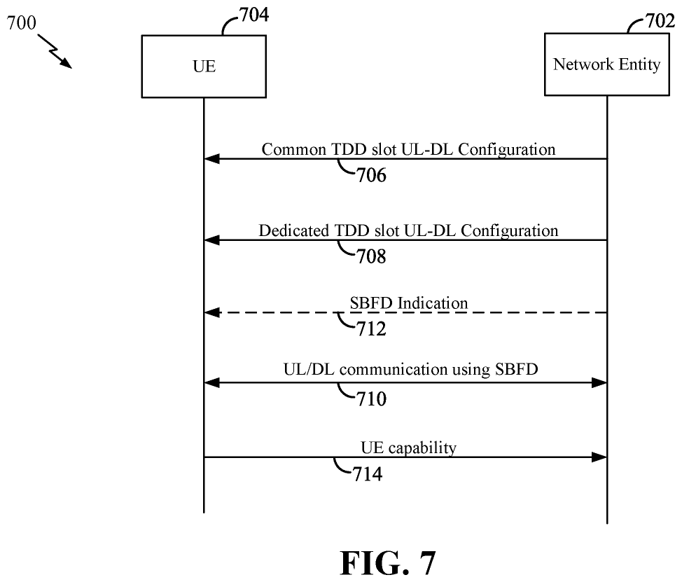

FIG. 7 is a signaling diagram illustrating exemplary signaling 700 for configuring SBFD communication between a network entity 702 and a UE 704 according to some aspects. The network entity 702 can provide a common TDD UL-DL slot configuration that can define a slot to be a UL, DL, or Flexible (F) slot. An F symbol/slot can be used for either UL or DL as needed or scheduled. In NR, slot format configuration can be static, semi-static, or fully dynamic. In some aspects, the TDD slot configuration can be broadcast from SIB1 or/and configured with an RRC Connection Reconfiguration message. In some aspects, static or semi-static configuration for a slot can be achieved using RRC, while dynamic slot configuration can be achieved using PDCCH DCI. In some aspects, if a slot configuration is not provided by the network through RRC messages, all the slots/symbols may be considered as flexible by default.

The network entity 702 can provide the common TDD UL-DL slot configuration 706 (e.g., tdd-UL-DL-ConfigurationCommon) to the UE 704 via RRC messages. The common TDD UL-DL slot configuration 706 can provide various parameters, such as the slot configuration period, a number of slots with only DL symbols, a number of DL symbols, a number of slots with only UL symbols, a number of uplink symbols, etc. The network entity can also provide the UE with a dedicated TDD slot format configuration 708 using RRC. For example, flexible (F) symbols configured by the tdd-UL-DL-ConfigurationCommon 706 can be re-assigned as a DL (D symbol) or UL (U symbol) via tdd-UL-DL-ConfigurationDedicated 708. At 710, the UE 704 can communicate with the network entity 702 using UL and/or DL communication in the configured TDD slot(s).

In some aspects, the network entity 702 can further indicate the symbol(s) and/or slot(s) (e.g., DL symbols/slots) that is/are SBFD capable such that the UE 704 knows which symbols/slots can be used for SBFD communication (e.g., UL communication using a UL sub-band in a DL symbol/slot). Knowing the SBFD capability and configuration of a symbol/slot enables the UE to improve resource utilization, reduce resource usage, and/or power usage.

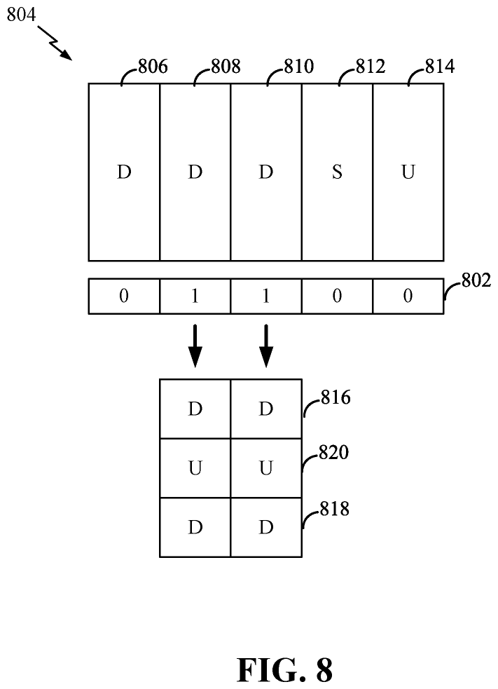

In some aspects, the network entity 702 can indicate the configured TDD symbol(s)/slot(s) (e.g., DL, UL, F symbols) that can be used for SBFD communication or not, for example, symbol(s)/slot(s) configured by the tdd-UL-DL-ConfigurationCommon 706. In one aspect, the tdd-UL-DL-ConfigurationCommon 706 can include the SBFD information (e.g., SBFD configuration) of the configured symbol(s)/slot(s). In one example, as shown in FIG. 8, the tdd-UL-DL-ConfigurationCommon 706 can include a bitmap 802 that indicates which DL symbol(s) of a plurality of configured TDD symbols 804 is/are SBFD symbol(s) that can be used for UL transmission using a UL sub-band. In FIG. 8, the bitmap 802 has an exemplary bit pattern of ‘01100’ with each bit corresponding to one of the symbols 806, 808, 810, 812, 814. In this example, a bit value 0 indicates that symbols 806, 812, and 814 are not SBFD capable, and a bit value 1 indicates that symbols 808 and 810 are SBFD symbols that can be used for SBFD (UL and DL using different sub-bands) communication in the same symbol. In one example, the SBFD symbol can provide one or more DL sub-bands (e.g., sub-bands 816 and 818) and an UL sub-band 820 that can be used for UL communication simultaneous to the DL communication in the same symbol.

Referring again to FIG. 7, in one aspect, the network entity can provide the SBFD information in the dedicated TDD slot format configuration 708 (e.g., tdd-UL-DL-ConfigurationDedicated). In some aspects, the network entity can provide the SBFD information (e.g., bitmap 802) in a separate message (e.g., SBFD indication 712) that is different from the tdd-UL-DL-ConfigurationCommon 706 and tdd-UL-DL-ConfigurationDedicated 708. In one aspect, the network entity can provide the SBFD information in a DCI or MAC control element (CE), for example, in a slot format indicator (SFI). In some aspects, the network entity can provide the SBFD information using a UE dedicated DCI format or group common DCI format (e.g., DCI format2_0 (SFI)). For example, the SFI may include the bitmap 802 that indicates the D symbol(s) that is SBFD capable.

In some aspects, the UE 704 can report (e.g., UE capability 714 or UE report) various SBFD-related capabilities. The UE 704 can report the UE capabilities autonomously or in response to a request by the network entity 702. For example, the UE can transmit the UE capability 714 in an RRC message (e.g., a UE report).

In some aspects, the UE 704 may report a UE capability to adaptively or dynamically change an UL filter bandwidth. For example, the UE 704 with this capability may be capable of reconfiguring an UL signal filter (e.g., a low pass filter for UL transmission) to different bandwidths, for example, a narrower UL sub-band bandwidth for UL communication in an SBFD symbol/slot to reduce its power consumption due to lower sampling rate used by the narrower UL bandwidth. In one example, using a narrower UL filter bandwidth may reduce cross link interference (CLI) between UL and DL communications.

In some aspects, the UE 704 may report a UE capability to adaptively or dynamically change a DL filter bandwidth. For example, the UE 704 with this capability may be capable of reconfiguring a DL signal filter (e.g., a low pass filter for DL transmission) to different bandwidths, for example, a narrower bandwidth for one or two DL sub-bands in an SBFD symbol/slot. The UE can reduce its power consumption when the UE uses a narrower DL bandwidth. The UE also can reduce CLI between UL and DL communications when the UE uses a narrower DL filter bandwidth.

In some aspects, the UE 704 can adaptively change both the UL filter and DL filter bandwidths or individually for SBFD operations as described above.

In some aspects, the UE 704 may stop (or refrain from) monitoring a DL signal in an UL sub-band of an indicated SBFD symbol/slot. For example, based on the SBFD configuration information described above (e.g., indicated by tdd-UL-DL-ConfigurationCommon 706, tdd-UL-DL-ConfigurationDedicated 708, or separate SBFD indication 712), the UE 704 does not expect to receive a DL signal (e.g., PDCCH) in an UL sub-band (e.g., UL sub-band 820) of a configured SBFD symbol. Therefore, the UE does not need to monitor the PDCCH in the UL sub-band. In this case, the UE can reduce its power and resource usage.

In some aspects, the UE 704 may ignore the reception of a downlink reference signal (e.g., CSI-RS) in an UL sub-band of a configured SBFD symbol/slot. For example, based on an SBFD configuration, the UE 704 can determine an UL sub-band configuration of an SBFD symbol/slot. If the CSI-RS configuration indicates a wideband CSI-RS configuration, the UE may ignore or disregard the reception of a CSI-RS in the UL sub-band of an SBFD symbol. Therefore, the UE does not need to monitor the CSI-RS in the UL sub-band. In this case, the UE can reduce its power and resource usage.

In some aspects, the UE 704 may maintain and use different sets of communication parameters for communicating with the network entity 702 using SBFD and half duplex symbols/slots. Some examples of communication parameters include modulation and coding scheme (MCS), transmission power, power control parameters, etc.

For example, the UE can use a first set of communication parameters for periodic communication (e.g., persistent scheduling, semi-persistent scheduling (SPS), configured grant (CG) occasions) in SBFD symbols/slots, and a second set of communication parameters for periodic communication in half duplex symbols/slots. The UE can adaptively switch between the different sets of configuration parameters based on whether the indication of applied symbols/slots is for SBFD communication or half duplex communication.

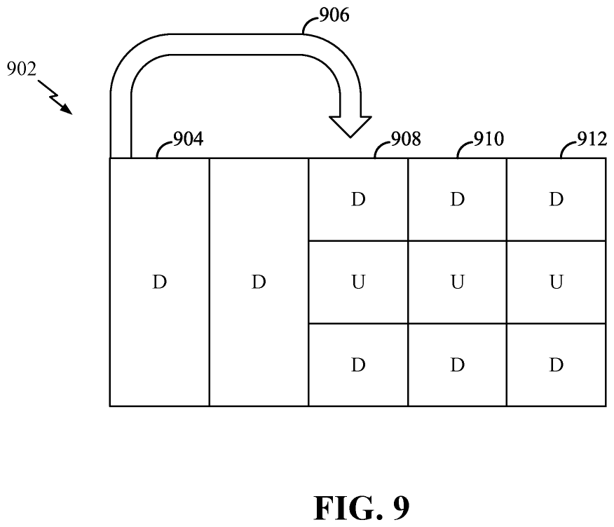

FIG. 9 illustrates another example of SBFD information indication using dynamic signaling according to some aspects of the disclosure. The network entity may have configured a plurality of symbols 902 using RRC (e.g., using common TDD slot format configuration 706 or dedicated TDD slot format configuration 708). In some aspects, the network entity can use dynamic signaling 906 (e.g., DCI or MAC control element (CE) received at a first symbol 904) to indicate one or more of the scheduled symbols is/are SBFD capable (i.e., simultaneous UL and DL using different sub-bands in the same symbol/slot). In some aspects, the DCI or MAC CE signaling 906 can provide a single bit or a bitmap (e.g., bitmap 802) that informs the UE whether one or more of scheduled symbols (e.g., symbols 908, 910, and 912) is/are SBFD capable. In one example, the dynamic signaling 906 can be a DCI that indicates an associated symbol is an SBFD symbol that is capable of SBFD operation. In this case, the DCI can also schedule UL transmission in the SBFD symbol using an UL sub-band. In one aspect, the dynamic signaling 906 can indicate that a previously indicated SBFD symbol (e.g., a periodic symbol) is converted or reverted back to half duplex operation (e.g., UL or DL only).

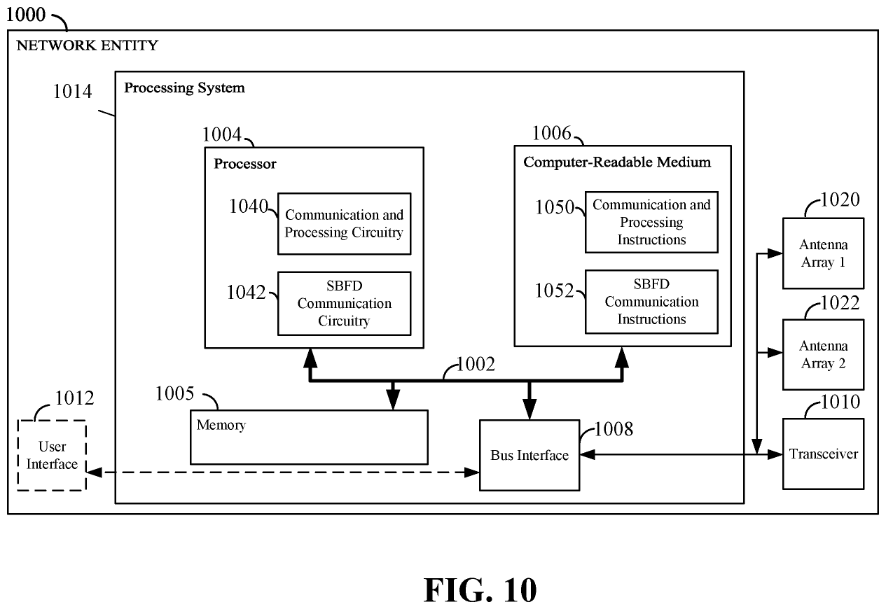

FIG. 10 is a block diagram illustrating an example of a hardware implementation for a network entity 1000 employing a processing system 1014. In one example, the network entity 1000 may be a base station (e.g., gNB) or network entity as illustrated in any one or more of FIGS. 1, 2, 6, and/or 7. The network entity 1000 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC.

The network entity 1000 may be implemented with a processing system 1014 that includes one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1000 may be configured to perform any one or more of the functions described herein. That is, the processor 1004, as utilized in a network entity 1000, may be used to implement any one or more of the processes and procedures described and illustrated in FIGS. 5-9 and 11.

The processor 1004 may in some instances be implemented via a baseband or modem chip and in other implementations, the processor 1004 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a communication interface or means for communicating (e.g., full duplex, half duplex, sub-band full duplex (SBFD), etc.) with various other apparatus over a transmission medium, for example, using one or antenna arrays 1020 and 1022. Depending upon the nature of the apparatus, a user interface 1012 (e.g., keypad, display, speaker, microphone, joystick, touchscreen) may also be provided. Of course, such a user interface 1012 is optional, and may be omitted in some examples, such as a network entity.

The processor 1004 is responsible for managing the bus 1002 and general processing, including the execution of software stored on the computer-readable medium 1006. The software, when executed by the processor 1004, causes the processing system 1014 to perform the various functions described below for any particular apparatus. The computer-readable medium 1006 and the memory 1005 may also be used for storing data that is manipulated by the processor 1004 when executing software.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006. The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1004 may include circuitry configured for various functions, including, for example, functions related to SBFD communication and configuration. For example, the circuitry may be configured to implement one or more of the functions described in relation to FIGS. 5-9 and 11.

In some aspects of the disclosure, the processor 1004 may include communication and processing circuitry 1040 configured for various functions, including for example communicating with a network core (e.g., a 5G core network), scheduled entities (e.g., UE), or any other entity, such as, for example, local infrastructure or an entity communicating with the network entity 1000 via the Internet, such as a network provider. In some examples, the communication and processing circuitry 1040 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1040 may include one or more transmit/receive chains. In addition, the communication and processing circuitry 1040 may be configured to receive and process uplink traffic and uplink control messages, transmit and process downlink traffic and downlink control messages. The communication and processing circuitry 1040 may further be configured to execute communication and processing software 1050 stored on the computer-readable medium 1006 to implement one or more functions described herein.

In some implementations where the communication involves receiving information, the communication and processing circuitry 1040 may obtain information from a component of the network entity 1000 (e.g., from the transceiver 1010 that receives the information via radio frequency signaling or some other type of signaling suitable for the applicable communication medium), process (e.g., decode) the information, and output the processed information. For example, the communication and processing circuitry 1040 may output the information to another component of the processor 1004, to the memory 1005, or to the bus interface 1008. In some examples, the communication and processing circuitry 1040 may receive one or more of signals, messages, other information, or any combination thereof. In some examples, the communication and processing circuitry 1040 may receive information via one or more channels. In some examples, the communication and processing circuitry 1040 may include functionality for a means for receiving. In some examples, the communication and processing circuitry 1040 may include functionality for a means for processing, including a means for demodulating, a means for decoding, etc.

In some implementations where the communication involves sending (e.g., transmitting) information, the communication and processing circuitry 1040 may obtain information (e.g., from another component of the processor 1004, the memory 1005, or the bus interface 1008), process (e.g., modulate, encode, etc.) the information, and output the processed information. For example, the communication and processing circuitry 1040 may output the information to the transceiver 1010 (e.g., that transmits the information via radio frequency signaling or some other type of signaling suitable for the applicable communication medium). In some examples, the communication and processing circuitry 1040 may send one or more of signals, messages, other information, or any combination thereof. In some examples, the communication and processing circuitry 1040 may send information via one or more channels. In some examples, the communication and processing circuitry 1040 may include functionality for a means for sending (e.g., a means for transmitting). In some examples, the communication and processing circuitry 1040 may include functionality for a means for generating, including a means for modulating, a means for encoding, etc.

In some aspects of the disclosure, the processor 1004 may include SBFD communication circuitry 1042 configured for various functions related to SBFD communication and operations. The SBFD communication circuitry 1042 can provide an SBFD configuration of one or more time slots, each time slot including a plurality of symbols. The SBFD configuration can indicate one or more of the plurality of symbols that are capable of an SBFD operation using one or more first sub-bands for DL communication and a second sub-band for UL communication. The network entity 1000 can communicate with a UE in the one or more symbols configured for SBFD communication using at least one of the first sub-band for DL communication or the second sub-band for UL communication.

In some aspects, the SBFD communication circuitry 1042 can provide an SBFD configuration that can be transmitted using RRC, DCI, and/or MAC CE signaling. The SBFD configuration can indicate the SBFD configuration of a plurality of symbols (one or more slots), for example, using a bitmap including one or more bits. Each bit of the bitmap can indicate the SBFD configuration of a corresponding symbol of the plurality of symbols.

In some aspects, the SBFD communication circuitry 1042 can be configured to provide an RRC message configured to indicate the SBFD configuration and a slot format configuration of the time slots. In some aspects, the SBFD communication circuitry 1042 can be configured to provide a first RRC message configured to indicate the SBFD configuration and a second RRC message, different from the first RRC message, configured to indicate a slot format configuration of the time slots.

In some aspects, the SBFD communication circuitry 1042 can be configured to provide a DCI configured to indicate the SBFD configuration and a slot format configuration of the time slots. In some aspects, the SBFD communication circuitry 1042 can be configured to provide a first DCI configured to indicate the SBFD configuration and a second DCI, different from the first DCI, configured to indicate a slot format configuration of the time slots.

In some aspects, the network entity can communicate with the UE in one or more symbols using a first set of communication parameters corresponding to the SBFD operation; and communicate with the UE in other symbols using a second set of communication parameters corresponding to a half duplex operation. The first set of communication parameters and the second set of communication parameters can be different in terms of MCS, power control parameters, and/or transmission power.

The SBFD communication circuitry 1042 may further be configured to execute SBFD communication software 1052 stored on the computer-readable medium 1006 to implement one or more functions described herein.

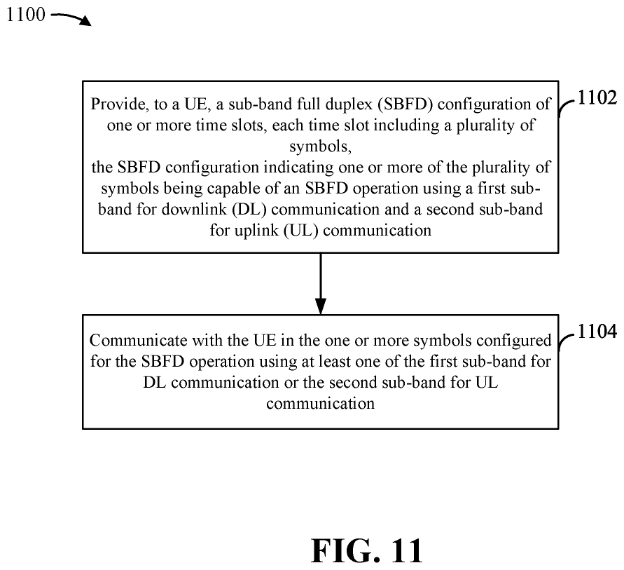

FIG. 11 is a flow chart illustrating an exemplary process 1100 for indicating an SBFD configuration in wireless communication in accordance with some aspects. As described below, some or all illustrated features may be omitted in a particular implementation within the scope of the present disclosure, and some illustrated features may not be required for implementation of all examples. In some examples, the process 1100 may be carried out by the network entity 1000 illustrated in FIG. 10. In some examples, the process 1100 may be carried out by any suitable apparatus or means for carrying out the functions or algorithm described below.

At block 1102, the network entity (e.g., a base station, gNB, CU, DU) can provide, to a UE, an SBFD configuration of one or more time slots, each time slot including a plurality of symbols. The SBFD configuration can indicate one or more of the plurality of symbols being capable of an SBFD operation using a first sub-band for DL communication and a second sub-band for UL communication. For example, the first sub-band may be similar to the sub-bands 816 and 818, and the second sub-band may be similar to the sub-band 820 described above in relation to FIG. 8. In one aspect, the SBFD communication circuitry 1042 can be a means to provide the SBFD configuration. In one example, the communication and processing circuitry 1040 can use the transceiver 1010 to transmit the SBFD configuration via one or more of the antenna arrays 1020 and 1022.

In some aspects, the network entity can provide (e.g., transmit) the SBFD configuration using RRC, DCI, and/or MAC CE signaling. For example, the SBFD communication circuitry 1042 can transmit and include the SBFD configuration in a common TDD slot format configuration 706 (e.g., tdd-UL-DL-ConfigurationCommon), a dedicated TDD slot format configuration 708 (e.g., tdd-UL-DL-ConfigurationDedicated), or an SBFD indication 712 as described above in relation to FIG. 7.

At block 1104, the network entity can communicate with the UE in the one or more symbols configured for the SBFD operation using at least one of the first sub-band for DL communication or the second sub-band for UL communication. In one aspect, the communication and processing circuitry 1040 can provide a means to communicate with the UE in the one or more symbols configured for the SBFD operation using the first sub-band for DL communication and/or the second sub-band for UL communication. In one example, the communication and processing circuitry 1040 can use the transceiver 1010 and one or more antenna arrays 1020 and 1022 to communicate with the UE using UL and/or DL communication in the one or more symbols configured for the SBFD operation.

In one aspect, the aforementioned means may be the processor shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 6, and/or 7, and utilizing, for example, the processes and/or algorithms described herein in relation to FIGS. 5-9 and/or 11.

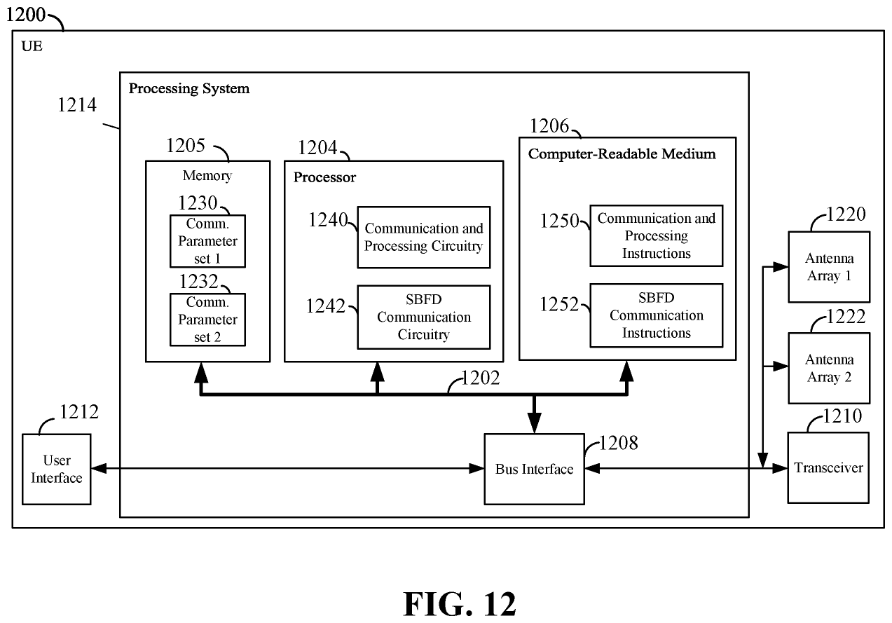

FIG. 12 is a diagram illustrating an example of a hardware implementation for an exemplary UE 1200 employing a processing system 1214. In accordance with various aspects of the disclosure, an element, or any portion of an element, or any combination of elements may be implemented with a processing system 1214 that includes one or more processors 1204. For example, the UE 1200 may be a UE or scheduled entity as illustrated in any one or more of FIGS. 1, 2, 6 and/or 7.

The processing system 1214 may be substantially the same as the processing system 1014 illustrated in FIG. 10, including a bus interface 1008, a bus 1002, memory 1005, a processor 1004, and a computer-readable medium 1006. Furthermore, the UE 1200 may include a user interface 1212 and a transceiver 1210 substantially similar to those described above in FIG. 10. Further, the UE 1200 may include one or more antenna arrays (e.g., antenna arrays 1220 and 1222) for UL and DL communication using, for example, SBFD and half duplex communication. That is, the processor 1204, as utilized in the UE 1200, may be used to implement any one or more of the processes described and illustrated in FIGS. 5-9 and 13.

In some aspects of the disclosure, the processor 1204 may include circuitry configured for various functions, including, for example, SBFD operations or communication using SBFD. For example, the circuitry may be configured to implement one or more of the functions described in relation to FIGS. 5-9 and 13.

In some aspects of the disclosure, the processor 1204 may include communication and processing circuitry 1240 configured for various functions, including for example communicating with a network entity (e.g., a base station, gNB, TRP). In some examples, the communication and processing circuitry 1240 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1240 may include one or more transmit/receive chains. In addition, the communication and processing circuitry 1240 may be configured to transmit and process uplink traffic and uplink control messages, receive and process downlink traffic and downlink control messages. The communication and processing circuitry 1240 may further be configured to execute communication and processing software 1250 stored on the computer-readable medium 1206 to implement one or more functions described herein.

In some implementations where the communication involves receiving information, the communication and processing circuitry 1240 may obtain information from a component of the wireless communication device 1200 (e.g., from the transceiver 1210 that receives the information via radio frequency signaling or some other type of signaling suitable for the applicable communication medium), process (e.g., decode) the information, and output the processed information. For example, the communication and processing circuitry 1240 may output the information to another component of the processor 1204, to the memory 1205, or to the bus interface 1208. In some examples, the communication and processing circuitry 1240 may receive one or more of signals, messages, other information, or any combination thereof. In some examples, the communication and processing circuitry 1240 may receive information via one or more channels. In some examples, the communication and processing circuitry 1240 may include functionality for a means for receiving. In some examples, the communication and processing circuitry 1240 may include functionality for a means for processing, including a means for demodulating, a means for decoding, etc.

In some implementations where the communication involves sending (e.g., transmitting) information, the communication and processing circuitry 1240 may obtain information (e.g., from another component of the processor 1204, the memory 1205, or the bus interface 1208), process (e.g., modulate, encode, etc.) the information, and output the processed information. For example, the communication and processing circuitry 1240 may output the information to the transceiver 1210 (e.g., that transmits the information via radio frequency signaling or some other type of signaling suitable for the applicable communication medium). In some examples, the communication and processing circuitry 1240 may send one or more of signals, messages, other information, or any combination thereof. In some examples, the communication and processing circuitry 1240 may send information via one or more channels. In some examples, the communication and processing circuitry 1240 may include functionality for a means for sending (e.g., a means for transmitting). In some examples, the communication and processing circuitry 1240 may include functionality for a means for generating, including a means for modulating, a means for encoding, etc.

In some aspects of the disclosure, the processor 1204 may include SBFD communication circuitry 1242 configured for various functions related to SBFD communication and operations. The SBFD communication circuitry 1242 can receive an SBFD configuration of one or more time slots, each time slot including a plurality of symbols. The SBFD configuration can indicate one or more of the plurality of symbols that are capable of an SBFD operation using a first sub-band for DL communication and a second sub-band for UL communication. The UE can communicate with a network entity (e.g., a base station) in the one or more symbols configured for the SBFD operation using at least one of the first sub-band for DL communication (e.g., using antenna array 1220) or the second sub-band for UL communication (e.g., using antenna array 1222) based on the SBFD configuration.

In some aspects, the UE 1200 (e.g., SBFD communication circuitry 1242) can receive an SBFD configuration from a network entity using RRC, DCI, and/or MAC CE signaling. The SBFD configuration can indicate the SBFD configuration (e.g., SBFD capability) of a plurality of symbols (in one or more slots), for example, using a bitmap including one or more bits. Each bit of the bitmap can indicate the SBFD configuration of a corresponding symbol of the plurality of symbols.

In some aspects, the UE 1200 (e.g., communication and processing circuitry 1240) can receive an RRC message configured to indicate the SBFD configuration and a slot format configuration of the one or more time slots. In some aspects, the communication and processing circuitry 1240 can be configured to receive a first RRC message configured to indicate the SBFD configuration and a second RRC message, different from the first RRC message, configured to indicate a slot format configuration of the one or more time slots.

In some aspects, the UE 1200 (e.g., communication and processing circuitry 1240) can receive a DCI configured to indicate the SBFD configuration and a slot format configuration of the one or more time slots. In some aspects, the communication and processing circuitry 1240 can be configured to receive a first DCI configured to indicate the SBFD configuration and a second DCI, different from the first DCI, configured to indicate a slot format configuration of the one or more time slots.

In some aspects, the UE can communicate with the network entity in one or more of the plurality of symbols using a first set of communication parameters 1230 corresponding to the SBFD operation; and communicate with the network entity in remaining symbols of the plurality of symbols using a second set of communication parameters 1232 corresponding to a half duplex operation. The UE may store the communication parameters 1230 and 1232 in the memory 1205 and select the set of parameters based on the SBFD configuration. The first set of communication parameters and the second set of communication parameters can be different in terms of MCS, power control parameters, and/or transmission power.

The SBFD communication circuitry 1242 may further be configured to execute SBFD communication software 1252 stored on the computer-readable medium 1206 to implement one or more functions described herein.

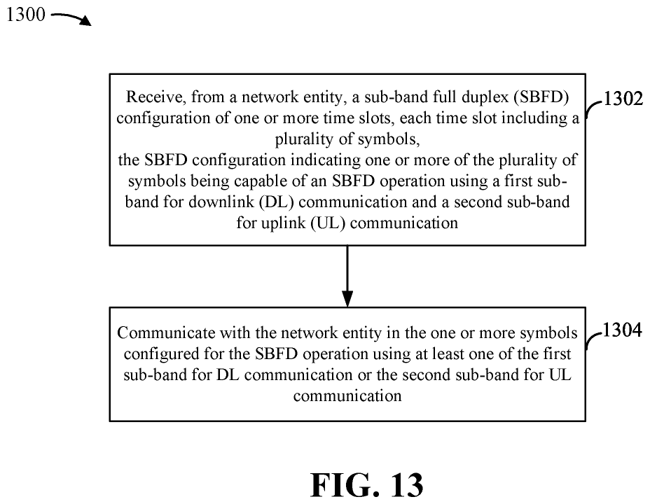

FIG. 13 is a flow chart illustrating an exemplary process 1300 for wireless communication based on an SBFD configuration in accordance with some aspects. As described below, some or all illustrated features may be omitted in a particular implementation within the scope of the present disclosure, and some illustrated features may not be required for the implementation of all examples. In some examples, the process 1300 may be carried out by the UE 1200 illustrated in FIG. 12. In some examples, the process 1300 may be carried out by any suitable apparatus or means for carrying out the functions or algorithm described below.

At block 1302, the UE can receive, from a network entity, an SBFD configuration of one or more time slots, each time slot including a plurality of symbols. In one aspect, the SBFD communication circuitry 1242 can provide a means to receive the SBFD configuration from a network entity (e.g., a base station, gNB) using the transceiver 1210 and one or more antenna arrays 1220 and 1222. For example, the SBFD communication circuitry 1242 can receive the SBFD configuration from the communication and processing circuitry 1240. The SBFD configuration can indicate that one or more of the plurality of symbols are capable of an SBFD operation using a first sub-band (e.g., sub-bands 816 and 818) for DL communication and a second sub-band (e.g., sub-band 820) for UL communication.

At block 1304, the UE can communicate with the network entity in the one or more symbols configured for the SBFD operation using at least one of the first sub-band for DL communication or the second sub-band for UL communication. In one aspect, the communication and processing circuitry 1240 and transceiver 1210 can provide a means to communicate with the network entity. In one example, the transceiver 1210 can use one or more antenna arrays 1220 and 1222 to communicate with the network entity using UL and/or DL communication in the one or more symbols configured for the SBFD operation.

In one aspect, the aforementioned means may be the processor shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 6, and/or 7, and utilizing, for example, the processes and/or algorithms described herein in relation to FIGS. 5-9 and/or 13.

A first aspect provides a method of wireless communication at a user equipment (UE). The method includes: receiving, from a network entity, a sub-band full duplex (SBFD) configuration of one or more time slots, each time slot comprising a plurality of symbols, the SBFD configuration indicating one or more of the plurality of symbols being capable of an SBFD operation using a first sub-band for downlink (DL) communication and a second sub-band for uplink (UL) communication; and communicating with the network entity in the one or more symbols configured for the SBFD operation using at least one of the first sub-band for DL communication or the second sub-band for UL communication.

In a second aspect, alone or in combination with the first aspect, the method further includes: receiving, from the network entity, the SBFD configuration in at least one of a first radio resource control (RRC) message, a first downlink control information (DCI), or a medium access control (MAC) control element (CE), the SBFD configuration comprising a bitmap including one or more bits, each bit of the bitmap indicating the SBFD configuration of a corresponding symbol of the plurality of symbols.

In a third aspect, alone or in combination with the second aspect, the method further includes receiving the first RRC message configured to indicate the SBFD configuration and a slot format configuration of the one or more time slots.

In a fourth aspect, alone or in combination with the second aspect, the method further includes: receiving the first RRC message configured to indicate the SBFD configuration; and receiving a second RRC message, different from the first RRC message, configured to indicate a slot format configuration of the one or more time slots.

In a fifth aspect, alone or in combination with the second aspect, the method further includes receiving the first DCI configured to indicate the SBFD configuration and a slot format configuration of the one or more time slots.

In a sixth aspect, alone or in combination with the second aspect, the method further includes: receiving the first DCI configured to indicate the SBFD configuration; and receiving a second DCI, different from the first DCI, configured to indicate a slot format configuration of the one or more time slots.

In a seventh aspect, alone or in combination with any of the second to sixth aspects, wherein each bit of the bitmap is configured to indicate: a corresponding symbol of the plurality of symbols being capable of SBFD operation; or a previously indicated SBFD symbol of the plurality of symbols being reverted back to a half duplex operation.

In an eighth aspect, alone or in combination with any of the first to sixth aspects, the method further includes at least one: transmitting a UE report indicating a capability of the UE to change a bandwidth of a signal filter configured for UL communication, and changing a bandwidth of the signal filter based on a bandwidth of the second sub-band; or transmitting a UE report indicating a capability of the UE to change a bandwidth of a signal filter configured for DL communication, and changing a bandwidth of the signal filter based on a bandwidth of the first sub-band.

In a ninth aspect, alone or in combination with any of the first to sixth aspects, the method further includes at least one of: refraining from monitoring a physical downlink control channel (PDCCH) in the first sub-band in the one or more symbols configured for the SBFD operation; or disregarding a downlink reference signal received in the first sub-band in the one or more symbols configured for the SBFD operation.

In a tenth aspect, alone or in combination with any of the first to sixth aspects, the method further includes: communicating with the network entity in the one or more of the plurality of symbols using a first set of communication parameters corresponding to the SBFD operation; and communicating with the network entity in remaining symbols of the plurality of symbols using a second set of communication parameters corresponding to a half duplex operation, wherein the first set of communication parameters and the second set of communication parameters are different in terms of at least one of: modulation and coding scheme (MCS), power control parameters, or transmission power.

An eleventh aspect provides a user equipment (UE), including a memory stored with executable code, and a processor coupled to the memory and configured by the executable code. The processor is configured to: receive, from a network entity, a sub-band full duplex (SBFD) configuration of one or more time slots, each time slot comprising a plurality of symbols, the SBFD configuration indicating one or more of the plurality of symbols being capable of an SBFD operation using a first sub-band for downlink (DL) communication and a second sub-band for uplink (UL) communication; and communicate with the network entity in the one or more symbols configured for the SBFD operation using at least one of the first sub-band for DL communication or the second sub-band for UL communication.

In a twelfth aspect, alone or in combination with the eleventh aspect, wherein the processor is further configured to: receive, from the network entity, the SBFD configuration in at least one of a first radio resource control (RRC) message, a first downlink control information (DCI), or a medium access control (MAC) control element (CE), the SBFD configuration comprising a bitmap including one or more bits, each bit of the bitmap indicating the SBFD configuration of a corresponding symbol of the plurality of symbols.

In a thirteenth aspect, alone or in combination with the twelfth aspect, wherein the processor is further configured to: receive the first RRC message configured to indicate the SBFD configuration and a slot format configuration of the one or more time slots; or receive the first RRC message configured to indicate the SBFD configuration, and receive a second RRC message, different from the first RRC message, configured to indicate a slot format configuration of the one or more time slots.

In a fourteenth aspect, alone or in combination with the twelfth aspect, wherein the processor is further configured to: receive the first DCI configured to indicate the SBFD configuration and a slot format configuration of the one or more time slots; or receive the first DCI configured to indicate the SBFD configuration, and receive a second DCI, different from the first DCI, configured to indicate a slot format configuration of the one or more time slots.

In a fifteenth aspect, alone or in combination with any of the twelfth to fourteenth aspects, wherein each bit of the bitmap is configured to indicate: a corresponding symbol of the plurality of symbols being capable of SBFD operation; or a previously indicated SBFD symbol of the plurality of symbols being reverted back to a half duplex operation.

A sixteenth aspect provides a method of wireless communication at a network entity. The network entity provides a sub-band full duplex (SBFD) configuration of one or more time slots, each time slot comprising a plurality of symbols, the SBFD configuration indicating one or more of the plurality of symbols being capable of an SBFD operation using a first sub-band for downlink (DL) communication and a second sub-band for uplink (UL) communication. The network entity communicates with a user equipment (UE) in the one or more symbols configured for the SBFD operation using at least one of the first sub-band for DL communication or the second sub-band for UL communication.

In a seventeenth aspect, alone or in combination with the sixteenth aspect, the method further includes: providing the SBFD configuration in at least one of a first radio resource control (RRC) message, a first downlink control information (DCI), or a medium access control (MAC) control element (CE), the SBFD configuration comprising a bitmap including one or more bits, each bit of the bitmap indicating the SBFD configuration of a corresponding symbol of the plurality of symbols.

In an eighteenth aspect, alone or in combination with the seventeenth aspect, the method further includes: providing the first RRC message configured to indicate the SBFD configuration and a slot format configuration of the one or more time slots.

In a nineteenth aspect, alone or in combination with the seventeenth aspect, the method further includes: providing the first RRC message configured to indicate the SBFD configuration; and providing a second RRC message, different from the first RRC message, configured to indicate a slot format configuration of the one or more time slots.

In a twentieth aspect, alone or in combination with the seventeenth, the method further includes: providing the first DCI configured to indicate the SBFD configuration and a slot format configuration of the one or more time slots.

In a twenty-first aspect, alone or in combination with the seventeenth aspect, the method further includes: providing the first DCI configured to indicate the SBFD configuration; and providing a second DCI, different from the first DCI, configured to indicate a slot format configuration of the one or more time slots.

In a twenty-second aspect, alone or in combination with any of the seventeenth to twenty-first aspects, wherein each bit of the bitmap is configured to indicate: a corresponding symbol of the plurality of symbols being capable of SBFD operation; or a previously indicated SBFD symbol of the plurality of symbols being reverted back to half duplex operation.

In a twenty-third aspect, alone or in combination with any of the sixteenth to twenty-first aspects, the method further includes: receiving a UE report indicating a capability of the UE to change at least one of a bandwidth of a signal filter configured for UL communication or a bandwidth of a signal filter configured for DL communication; and changing at least one of a bandwidth of the first sub-band or a bandwidth of the second sub-band according to the capability of the UE.

In a twenty-fourth aspect, alone or in combination with any of the sixteenth to twenty-first aspects, the method further includes: communicating with the UE using a first set of communication parameters corresponding to the SBFD configuration; and communicating with the UE using a second set of communication parameters corresponding to a half duplex configuration, wherein the first set of communication parameters and the second set of communication parameters are different in terms of at least one of modulation and coding scheme (MCS), power control parameters, or transmission power.

A twenty-fifth aspect provides a network entity including a memory stored with executable code, and a processor coupled to the memory and configured by the executable code. The processor is configured to provide a sub-band full duplex (SBFD) configuration of one or more time slots, each time slot comprising a plurality of symbols, the SBFD configuration indicating one or more of the plurality of symbols being capable of an SBFD operation using a first sub-band for downlink (DL) communication and a second sub-band for uplink (UL) communication. The process is further configured to communicate with a user equipment (UE) in the one or more symbols configured for the SBFD operation using at least one of the first sub-band for DL communication or the second sub-band for UL communication.

In a twenty-sixth aspect, alone or in combination with the twenty-fifth aspect, wherein the processor is further configured to: provide the SBFD configuration in at least one of a first radio resource control (RRC) message, a first downlink control information (DCI), or a medium access control (MAC) control element (CE), the SBFD configuration comprising a bitmap including one or more bits, each bit of the bitmap indicating the SBFD configuration of a corresponding symbol of the plurality of symbols.

In a twenty-seventh aspect, alone or in combination with the twenty-sixth aspect, wherein the processor is further configured to: provide the first RRC message configured to indicate the SBFD configuration and a slot format configuration of the one or more time slots; or provide the first RRC message configured to indicate the SBFD configuration, and provide a second RRC message, different from the first RRC message, configured to indicate a slot format configuration of the one or more time slots.

In a twenty-eighth aspect, alone or in combination with the twenty-sixth aspect, wherein the processor is further configured to: provide the first DCI configured to indicate the SBFD configuration and a slot format configuration of the one or more time slots; or provide the first DCI configured to indicate the SBFD configuration; and provide a second DCI, different from the first DCI, configured to indicate a slot format configuration of the one or more time slots.

In a twenty-ninth aspect, alone or in combination with any of the twenty-sixth to twenty-eighth aspects, wherein each bit of the bitmap is configured to indicate: a corresponding symbol of the plurality of symbols being capable of SBFD operation; or a previously indicated SBFD symbol of the plurality of symbols being reverted back to half duplex operation.

In a thirtieth aspect, alone or in combination with any of the twenty-sixth to twenty-eighth aspects, the processor is further configured to: communicate with the UE using a first set of communication parameters corresponding to the SBFD configuration; and communicate with the UE using a second set of communication parameters corresponding to a half duplex configuration, wherein the first set of communication parameters and the second set of communication parameters are different in terms of at least one of modulation and coding scheme (MCS), power control parameters, or transmission power.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication at a user equipment (UE), comprising:
receiving, from a network entity, a sub-band full duplex (SBFD) configuration of one or more time slots, each time slot comprising a plurality of symbols,
the SBFD configuration indicating one or more of the plurality of symbols being capable of an SBFD operation using a first sub-band for downlink (DL) communication and a second sub-band for uplink (UL) communication; and
communicating with the network entity in the one or more symbols configured for the SBFD operation using at least one of the first sub-band for DL communication or the second sub-band for UL communication.

2. The method of claim 1, further comprising:
receiving, from the network entity, the SBFD configuration in at least one of a first radio resource control (RRC) message, a first downlink control information (DCI), or a medium access control (MAC) control element (CE),
the SBFD configuration comprising a bitmap including one or more bits, each bit of the bitmap indicating the SBFD configuration of a corresponding symbol of the plurality of symbols.

3. The method of claim 2, further comprising:
receiving the first RRC message configured to indicate the SBFD configuration and a slot format configuration of the one or more time slots.

4. The method of claim 2, further comprising:
receiving the first RRC message configured to indicate the SBFD configuration; and
receiving a second RRC message, different from the first RRC message, configured to indicate a slot format configuration of the one or more time slots.

5. The method of claim 2, further comprising:
receiving the first DCI configured to indicate the SBFD configuration and a slot format configuration of the one or more time slots.

6. The method of claim 2, further comprising:
receiving the first DCI configured to indicate the SBFD configuration; and
receiving a second DCI, different from the first DCI, configured to indicate a slot format configuration of the one or more time slots.

7. The method of claim 2, wherein each bit of the bitmap is configured to indicate:
a corresponding symbol of the plurality of symbols being capable of SBFD operation; or
a previously indicated SBFD symbol of the plurality of symbols being reverted back to a half duplex operation.

8. The method of claim 1, further comprising at least one:
transmitting a UE report indicating a capability of the UE to change a bandwidth of a signal filter configured for UL communication, and changing a bandwidth of the signal filter based on a bandwidth of the second sub-band; or
transmitting a UE report indicating a capability of the UE to change a bandwidth of a signal filter configured for DL communication, and changing a bandwidth of the signal filter based on a bandwidth of the first sub-band.

9. The method of claim 1, further comprising at least one of:
refraining from monitoring a physical downlink control channel (PDCCH) in the first sub-band in the one or more symbols configured for the SBFD operation; or
disregarding a downlink reference signal received in the first sub-band in the one or more symbols configured for the SBFD operation.

10. The method of claim 1, further comprising:
communicating with the network entity in the one or more of the plurality of symbols using a first set of communication parameters corresponding to the SBFD operation; and
communicating with the network entity in remaining symbols of the plurality of symbols using a second set of communication parameters corresponding to a half duplex operation,
wherein the first set of communication parameters and the second set of communication parameters are different in terms of at least one of: modulation and coding scheme (MCS), power control parameters, or transmission power.

11. A user equipment (UE), comprising:
a memory stored with executable code; and
a processor coupled to the memory and configured by the executable code, the processor being configured to:
receive, from a network entity, a sub-band full duplex (SBFD) configuration of one or more time slots, each time slot comprising a plurality of symbols,
the SBFD configuration indicating one or more of the plurality of symbols being capable of an SBFD operation using a first sub-band for downlink (DL) communication and a second sub-band for uplink (UL) communication; and
communicate with the network entity in the one or more symbols configured for the SBFD operation using at least one of the first sub-band for DL communication or the second sub-band for UL communication.

12. The UE of claim 11, wherein the processor is further configured to:
receive, from the network entity, the SBFD configuration in at least one of a first radio resource control (RRC) message, a first downlink control information (DCI), or a medium access control (MAC) control element (CE),
the SBFD configuration comprising a bitmap including one or more bits, each bit of the bitmap indicating the SBFD configuration of a corresponding symbol of the plurality of symbols.

13. The UE of claim 12, wherein the processor is further configured to:
receive the first RRC message configured to indicate the SBFD configuration and a slot format configuration of the one or more time slots; or
receive the first RRC message configured to indicate the SBFD configuration, and receive a second RRC message, different from the first RRC message, configured to indicate a slot format configuration of the one or more time slots.

14. The UE of claim 12, wherein the processor is further configured to:
receive the first DCI configured to indicate the SBFD configuration and a slot format configuration of the one or more time slots; or
receive the first DCI configured to indicate the SBFD configuration, and receive a second DCI, different from the first DCI, configured to indicate a slot format configuration of the one or more time slots.

15. The UE of claim 12, wherein each bit of the bitmap is configured to indicate:
a corresponding symbol of the plurality of symbols being capable of SBFD operation; or
a previously indicated SBFD symbol of the plurality of symbols being reverted back to a half duplex operation.

16. A method of wireless communication at a network entity, comprising:
providing a sub-band full duplex (SBFD) configuration of one or more time slots, each time slot comprising a plurality of symbols,
the SBFD configuration indicating one or more of the plurality of symbols being capable of an SBFD operation using a first sub-band for downlink (DL) communication and a second sub-band for uplink (UL) communication; and
communicating with a user equipment (UE) in the one or more symbols configured for the SBFD operation using at least one of the first sub-band for DL communication or the second sub-band for UL communication.

17. The method of claim 16, further comprising:
providing the SBFD configuration in at least one of a first radio resource control (RRC) message, a first downlink control information (DCI), or a medium access control (MAC) control element (CE),
the SBFD configuration comprising a bitmap including one or more bits, each bit of the bitmap indicating the SBFD configuration of a corresponding symbol of the plurality of symbols.

18. The method of claim 17, further comprising:
providing the first RRC message configured to indicate the SBFD configuration and a slot format configuration of the one or more time slots.

19. The method of claim 17, further comprising:
providing the first RRC message configured to indicate the SBFD configuration; and
providing a second RRC message, different from the first RRC message, configured to indicate a slot format configuration of the one or more time slots.

20. The method of claim 17, further comprising:
providing the first DCI configured to indicate the SBFD configuration and a slot format configuration of the one or more time slots.

21. The method of claim 17, further comprising:
providing the first DCI configured to indicate the SBFD configuration; and
providing a second DCI, different from the first DCI, configured to indicate a slot format configuration of the one or more time slots.

22. The method of claim 17, wherein each bit of the bitmap is configured to indicate:
a corresponding symbol of the plurality of symbols being capable of SBFD operation; or
a previously indicated SBFD symbol of the plurality of symbols being reverted back to half duplex operation.

23. The method of claim 16, further comprising:
receiving a UE report indicating a capability of the UE to change at least one of a bandwidth of a signal filter configured for UL communication or a bandwidth of a signal filter configured for DL communication; and
changing at least one of a bandwidth of the first sub-band or a bandwidth of the second sub-band according to the capability of the UE.

24. The method of claim 16, further comprising:
communicating with the UE using a first set of communication parameters corresponding to the SBFD configuration; and
communicating with the UE using a second set of communication parameters corresponding to a half duplex configuration,
wherein the first set of communication parameters and the second set of communication parameters are different in terms of at least one of: modulation and coding scheme (MCS), power control parameters, or transmission power.

25. A network entity comprising:
a memory stored with executable code; and
a processor coupled to the memory and configured by the executable code, the processor being configured to:
provide a sub-band full duplex (SBFD) configuration of one or more time slots, each time slot comprising a plurality of symbols,
the SBFD configuration indicating one or more of the plurality of symbols being capable of an SBFD operation using a first sub-band for downlink (DL) communication and a second sub-band for uplink (UL) communication; and
communicate with a user equipment (UE) in the one or more symbols configured for the SBFD operation using at least one of the first sub-band for DL communication or the second sub-band for UL communication.

26. The network entity of claim 25, wherein the processor is further configured to:
provide the SBFD configuration in at least one of a first radio resource control (RRC) message, a first downlink control information (DCI), or a medium access control (MAC) control element (CE),
the SBFD configuration comprising a bitmap including one or more bits, each bit of the bitmap indicating the SBFD configuration of a corresponding symbol of the plurality of symbols.

27. The network entity of claim 26, wherein the processor is further configured to:
provide the first RRC message configured to indicate the SBFD configuration and a slot format configuration of the one or more time slots; or
provide the first RRC message configured to indicate the SBFD configuration, and provide a second RRC message, different from the first RRC message, configured to indicate a slot format configuration of the one or more time slots.

28. The network entity of claim 26, wherein the processor is further configured to:
provide the first DCI configured to indicate the SBFD configuration and a slot format configuration of the one or more time slots; or
provide the first DCI configured to indicate the SBFD configuration; and provide a second DCI, different from the first DCI, configured to indicate a slot format configuration of the one or more time slots.

29. The network entity of claim 26, wherein each bit of the bitmap is configured to indicate:
a corresponding symbol of the plurality of symbols being capable of SBFD operation; or
a previously indicated SBFD symbol of the plurality of symbols being reverted back to half duplex operation.

30. The network entity of claim 26, wherein the processor is further configured to:
communicate with the UE using a first set of communication parameters corresponding to the SBFD configuration; and
communicate with the UE using a second set of communication parameters corresponding to a half duplex configuration,
wherein the first set of communication parameters and the second set of communication parameters are different in terms of at least one of: modulation and coding scheme (MCS), power control parameters, or transmission power.
